(19) United States
(12) Patent Application Publication
(10) Pub. No.: US 2004/0081076 A1
(43) Pub. Date: Apr. 29, 2004

(54) Method, apparatus and system for orthogonal frequency division multiplexing power control

(75) Inventors: Yuri Goldstein, Southbury, CT (US); Yuri Okunev, Southbury, CT (US)

Correspondence Address: David P. Gordon, Esq., 65 Woods End Road, Stamford, CT, 06905, US

(73) Assignee: PCTEL, Inc.

(21) Appl. No.: 10/279,612

(22) Filed: Oct. 24, 2002

(51) Int. Cl. H04J 11/00; H04J 1/16

(52) U.S. Cl. 370/208; 370/318

(57) ABSTRACT

Data carrier duplication (DCD) is used to implement power control in multipoint-to-point OFDM systems. In DCD, data on several carriers (i.e., frequencies) is utilized in order to increase the power of a channel. Data carrier duplication not only provides power control capabilities, but it also mitigates selective fading problems. In a “closed loop power control” (CLPC) scheme, a hub is provided with certain intelligence which allows it to provide optimal distribution of carriers among nodes. In an “open loop power control” (OLPC) scheme, the nodes are provided with more intelligence to allow them to determine the number of additional carriers they require for transmitting data.

### BACKGROUND OF THE INVENTION

1. Field of the Invention

The present invention relates to wireless telecommunications. The present invention more particularly relates to power control methods and apparatus for wireless telecommunications systems utilizing orthogonal frequency division multiplexing (OFDM).

2. State of the Art

Orthogonal Frequency Division Multiplexing (OFDM) is a well known technique which is used in a wide variety of wire and wireless telecommunication systems. OFDM is a spectrally efficient transmission technique which distributes and transmits data synchronously over a large number of carriers that are spaced apart at precise frequencies. Because multicarrier OFDM systems have a much smaller symbol rate than equivalent single carrier systems, OFDM systems have various advantages.

In wire channels, OFDM allows a system to decrease intersymbol interference and simplify equalization procedures. Thus OFDM is used in high speed x.DSL systems such as G.992.1 and VDSL. In wireless channels, OFDM allows a system to mitigate the effects of multipath propagation and provide high data rates in the multibeam environment. Thus, OFDM technology is a basis for Wireless Local Area Network (WLAN) standard IEEE.802.11a in the 5 GHz frequency band. See, IEEE 802.11a-1999, Part 11, Section 17.1: “Wireless LAN Medium Access Control (MAC) and Physical Layer (PHY) specifications, High-speed Physical Layer in the 5 GHz Band” which is hereby incorporated by reference herein in its entirety. According to the standard, 52-carrier OFDM (with 48 carriers used for data transmission and 4 carriers used as pilots) provides up to 54 Mbit/s within a 20 MHz bandwidth in a multibeam environment with beam delays up to 800 ns. Likewise, OFDM technology is recommended in a draft IEEE.802.16 standard for fixed broadband wireless access systems in frequency range 2-11 GHz. See IEEE 802.16ab, Section 8.3.5.1 “Standard Air Interface for Fixed Broadband Wireless Access Systems—Media Access Control Modifications and Additional Physical Layer for 2-11 GHz”, which is hereby incorporated by reference herein in its entirety. OFDM is also the most promising candidate for WLAN implementation in the 60 GHz frequency band. See, Peter Smulders, “Exploiting the 60 GHz Band for Local Wireless Multimedia Access: Prospects and Future Directions”, IEEE Communications, Vol.40, No. 1, January 2002, which is hereby incorporated by reference herein in its entirety.

Typical OFDM applications include multipoint-to-point and point-to-multipoint transmissions; the latter being illustrated in prior art FIG. 1. In a point-to-multipoint transmission, a wireless system 10 is comprised of a central station or hub 20, and a plurality (N) of user stations or nodes 30. The central station 20 may be a base station (BS) in a mobile or fixed wireless network, or it may be an access point (AP) in a WLAN. The nodes 30 may be any individual devices of the wireless network. For example, in a WLAN environment, a node may be PC, laptop, printer, VoIP cordless phone, etc. In FIG. 1, transmitted signals in the frequency domain are schematically shown at the bottom of the figure. The frequency domain includes M carriers, numerated from 1 to M.

The key feature of point-to-multipoint OFDM application is that the hub 20 sends signal to all nodes 30 simultaneously, but only one of the nodes 30 can transmit a signal within any given time interval. FIG. 1 shows that only the i'th node is currently transmitting a signal to the hub 20 utilizing all carriers for data transmission at the given moment. Practically it means that the system utilizes a kind of time division access protocol, for example, regular time division multiple access (TDMA) or random channel access based on carrier sense multiple access (CSMA).

Point-to-multipoint OFDM transmission allows the system to avoid a power control problem because at any moment each receiver receives the signal from one single transmitter. Therefore, the existing WLAN IEEE.802.11a standard supports only point-to-multipoint transmission. Even with an ad hoc mode, when there is no the centralized controller-hub, the standard allows transmitting the signal only from one single transmitter at any moment.

On the other hand, point-to-multipoint mode cannot exploit system capacity efficiently. For example, it will be appreciated that where a VoIP (voice over IP) cordless phone is one of the nodes, the VoIP phone does not need a high data rate but should provide high quality digital voice transmission in real time. As a result, when a cordless phone is active, it uses only a small part of the system capacity, but forces all other nodes to wait for it to get off the air.

One possible manner of solving this problem is to utilize a multipoint-to-point mode, which allows the nodes to transmit data simultaneously while using only a part of the system capacity for each node. The multipoint-to-point approach is considered in detail for WLAN applications based on IEEE 802.11a standard in Bill McFarland at al., “The 5-UP Protocol for Unified Multiservice Wireless Networks”, IEEE Communications, Vol.39, No.11, November 2001, which is hereby incorporated by reference herein in its entirety. The multipoint-to-point mode is illustrated in prior art FIG. 2, which includes a hub 40 and a plurality of nodes 50 (as in FIG. 1). The difference between the multipoint-to-point system of FIG. 2 and the point-to-multipoint system of FIG. 1 is that in the former, all nodes 50 have an opportunity to send signals to the hub 40 in a simultaneous manner (in parallel) by using corresponding parts of the carrier set. As seen in FIG. 2, the first node 50a (e.g., a cordless phone) transmits its data on the first carrier, the second node 50b transmits on the second carrier and on the M-5'th carrier, and so on. Distribution of carriers between the nodes is a function of the hub. Practically, this distribution, based on node demands, transforms the OFDM technique into the orthogonal frequency division multiple access (OFDMA) method.

OFDMA is an extended OFDM technique, which provides the most efficient exploitation of the multicarrier system capacity. However, OFDMA has several additional issues in comparison to the traditional point-to-multipoint OFDM. These issues arise at the physical layer because of differences in signal transformation and propagation which result from path differences from the individual nodes to the hub. Four undesirable consequences of these differences at the receiving site are: the carriers have different powers; the carriers have different frequency offsets; the carriers have different time delays; and the carriers are subjected to selective (narrowband) fading. Thus, the following issues correspond to the undesirable consequences: power control; frequency adjustment; timing adjustment; and selective fading mitigation.

In the OFDM system all carriers at the input of the receiver should have, as far as possible, the same power. If, for example, the i'th carrier has much more power than the j'th carrier, then the j'th carrier may be subjected to severe interference from the i'th carrier if the orthogonality of the carriers in the receiver is not ideal.

CDMA spread spectrum cellular systems, where orthogonality of user signals is conceptually imperfect, utilizes a very sophisticated power control algorithm, which forces users near the base station to decrease power and users distant the base station to increase power. By means of these “decrease/increase power” manipulations the algorithm adjusts power from different transmitters within 1 dB at the input of the receiver. Power adjustment requirements for OFDM systems depend on frequency offset between different transmitter signals. According to Bill McFarland at al., “The 5-UP Protocol for Unified Multiservice Wireless Networks”, IEEE Communications, Vol.39, No.11, November 2001, if the frequency offset is within a few ppm, power control within ±3 dB is sufficient.

The existing method of power control, based on the “decrease/increase power” procedure, has a number of disadvantages. First of all, the necessity of changing the transmission power within a large dynamic range and with a given accuracy considerably complicates the power amplifier in the transmitter. Second, increasing the single carrier power does not lead to required performance improvement in channels with frequency selective fading, and it forces developers to use additional means, for example, antenna diversity in the receiver in order to achieve desired performance.

### SUMMARY OF THE INVENTION

It is therefore an object of the invention to provide methods, apparatus, and systems for providing power control in multipoint-to-point OFDM systems.

It is another object of the invention to provide power control mechanisms in OFDM systems which do not require complex amplifiers.

It is a further object of the invention to provide power control mechanisms in OFDM systems which help overcome selective fading issues.

In accord with the objects of the invention, the methods, apparatus, and systems of the invention utilize a data carrier duplication (DCD) technique in order to implement power control in multipoint-to-point OFDM systems. The essence of the DCD technique which is common to all embodiments of the invention is the duplication of data on several carriers (i.e., frequencies) in order to increase the power of a channel. Data carrier duplication not only provides power control capabilities, but it also mitigates selective fading problems.

Various embodiments of the invention are provided. In a first preferred embodiment called a “closed loop power control” (CLPC) scheme, the hub is provided with certain intelligence which allows it to provide optimal distribution of carriers among nodes; i.e., maximum frequency diversity of carriers bearing the same information symbol. In the CLPC scheme, the hub provides a preliminary assignment of carriers for all nodes participating in a given session. All active nodes then transmit on the assigned carriers with a maximum possible power level or with a given initial power level. The hub receiver measures and estimates the signal powers of all of the received individual carriers. If the difference between powers of the individual carriers does not exceed a given threshold (for example, 3 dB), the hub allows the nodes to transmit data on the preliminary assigned carriers with no power changes. If, however, the difference between powers of the individual carriers exceeds the given threshold (for example, 3 dB), the hub provides two step power correction. First, the powers of the nodes having maximum power at the input of the hub are decreased up to a given nominal level necessary to support required performance. If after that correction the difference between powers of the individual carriers does not exceed the given threshold (for example, 3 dB), the hub allows the nodes to transmit data on the preliminary assigned carriers with the estimated power changes. Otherwise, the hub uses data carrier duplication to reassign carriers for nodes with minimum power at the input of the hub. In this way these nodes are able to duplicate their data on several carriers depending on how much power gain is needed; i.e., the number of carriers utilized will depend upon how much power gain is required for that node. If, after the carrier reassignment the power difference between individual carriers and duplicated carrier groups does not exceed the given threshold (for example, 3 dB), the hub allows the nodes to transmit data on the finally assigned carriers with given power changes and carrier duplications.

A second preferred embodiment of the invention is an open loop power control (OLPC) scheme. In the OLPC scheme the node is provided with sufficient intelligence to make independent decision about carrier duplications and send the corresponding request regarding carrier assignment to the hub. More particularly, in the OLPC scheme, the hub provides a preliminary assignment of carriers for all the nodes participating in a given session. The node receiver measures and estimates the average power Pa of the assigned carriers transmitted by the hub and calculates a difference Dp between the estimated power and some predetermined nominal level Pn; i.e., Dp=Pa−Pn. If the calculated difference Dp is within a given threshold ±Th, (e.g., if −3 dB<Dp<3 dB), then the node transmits data on the preliminary assigned carriers without any power changes. On the other hand, Dp>Th (e.g., Dp>3 dB), then the node decreases the power of the preliminary assigned carriers to provide a difference between the corrected power and the predetermined nominal level within the given threshold and transmits data on the preliminary assigned carriers with the corresponding power changes. If Dp<−Th (e.g., if Dp<−3 dB), then the node determines the number of duplications (i.e., the number of carriers) required for the corresponding power gain, and transmits to the hub a request for additional carriers (or uses predetermined reserved carriers), and then transmits data on assigned duplicated carriers.

According to the invention, the preferred DCD method of power control can be used in combination with conventional “decrease/increase power” algorithms. Thus, for example, if the power of some node should be increased, the desired power gain may be achieved partly by increasing the assigned carrier power and partly by carrier duplication. For example, if a node is to transmit data on a carrier, and the hub has asked the node to increase the carrier power by 6 dB (four times), and the node has only 3 dB power in reserve, then the node can solve the problem in several ways. First, the node can transmit its data on four carriers in parallel without increasing its transmitter power, and the total power gain will be about 6 dB as required. Second, the node can increase its transmitter power by 3 dB, and in addition, transmit its data on two carriers in parallel to provide another 3 dB gain; for a total power gain of about 6 dB. Third, the node can increase its transmitter power by less than 3 dB, and use three or more carriers in parallel to provide the remainder of the desired gain. Thus, the combination of carrier duplications with carrier power increase allows the system to decrease the required dynamic range of the transmitter and to therefore simplify the transmitter.

According to another aspect of the invention, the duplicated carriers used according to the DCD technique are frequency separated as much as possible. The frequency diversity mitigates selective fading problems.

Additional objects and advantages of the invention will become apparent to those skilled in the art upon reference to the detailed description taken in conjunction with the provided figures.

### BRIEF DESCRIPTION OF THE DRAWINGS

FIG. 1 is a high level schematic diagram of an OFDM point-to-multipoint mode telecommunication system of the prior art.

FIG. 2 is a high level schematic diagram of an OFDM multipoint-to-point mode telecommunication system of the prior art.

FIGS. 3a and 3b are high level block diagrams of an OFDM hub and OFDM node.

FIG. 4 is a functional chart for a closed loop power control system with carrier duplication according to a first embodiment of the invention.

FIG. 5 is a high level flow chart of the closed loop power control system and showing communications between the hub and the node.

FIG. 6 is a functional chart of an open loop power control system with carrier duplication according to a second embodiment of the invention.

FIG. 7 is a high level flow chart of the open loop power control system and showing communications between the hub and the node.

FIGS. 8a-8c are diagrams illustrating how the methods, apparatus and system of the invention mitigate the influence of frequency offset.

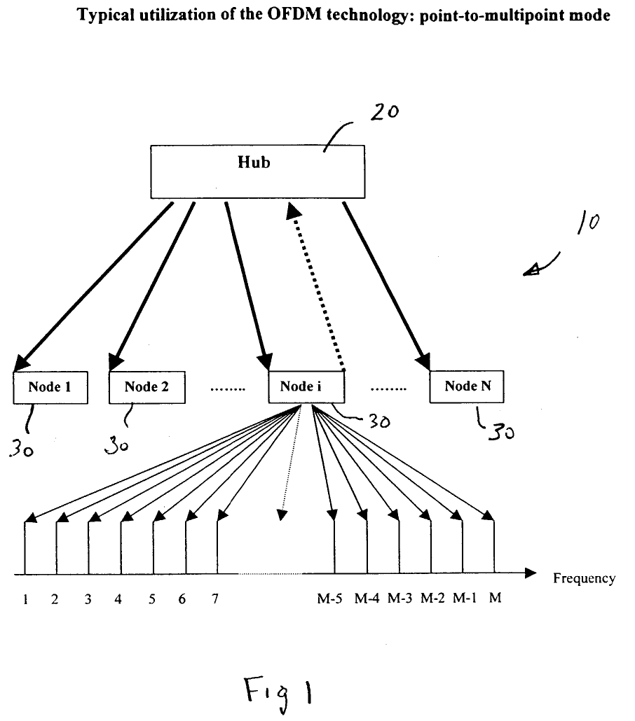

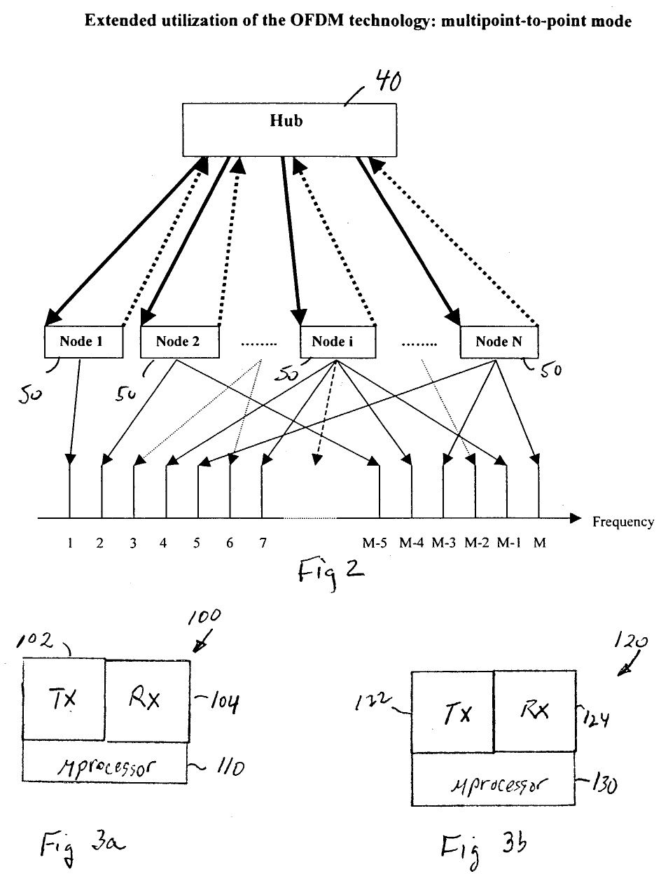

### DETAILED DESCRIPTION OF THE PREFERRED EMBODIMENTS

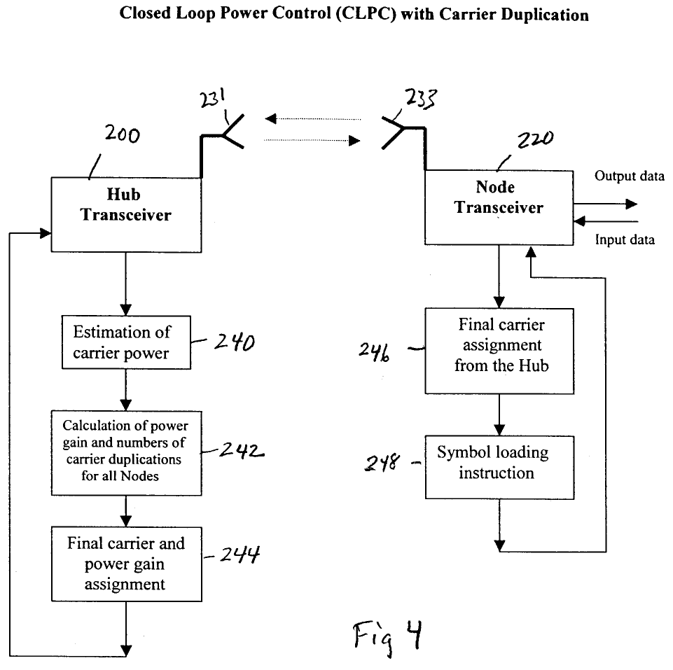

Turning to FIGS. 3a and 3b, high level block diagrams of an OFDM hub 100 and an OFDM node 120 are seen. As will be appreciated, both the hub and node may be implemented in a wide variety of manners, including hardware, software, and a combination of the two. The hub 100 of FIG. 3a is shown as including a transmitter 102, a receiver 104, and a processor 110 coupled to the transmitter 102 and receiver 104. Those skilled in the art will appreciate that the transmitter and receiver may include antennae (not shown) which may be shared or dedicated. Thus, the transmitter 102 is capable of transmitting orthogonal frequency division multiplexed information (e.g., on forty-eight different frequencies), and the receiver 104 is capable of receiving such OFDM information. The processor 110 is capable of processing such information, and in the preferred embodiments of the invention discussed hereinafter, is capable of implementing data carrier duplication in conjunction with one or more nodes. The difference between hub 100 and the hubs of the prior art is the capability of the hub 100 in implementing data carrier duplication as discussed hereinafter.

The node 120 of FIG. 3b is shown as including a transmitter 122, a receiver 124, and a processor 130 coupled to the transmitter 122 and receiver 124. Those skilled in the art will appreciate that the transmitter and receiver of the node may include antennae (not shown) which may be shared or dedicated. Thus, the transmitter 122 is capable of transmitting orthogonal frequency division multiplexed information (e.g., on forty-eight different frequencies), and the receiver 124 is capable of receiving such OFDM information. The processor 130 is capable of processing such information, and in the preferred embodiments of the invention discussed hereinafter, is capable of implementing data carrier duplication in conjunction with a hub. The difference between the node 120 and the nodes of the prior art is the capability of the node 120 in implementing data carrier duplication as discussed hereinafter.

Data carrier duplication may be understood as follows. Assume that the i'th node in wireless network generally requires only a single carrier for data transmission. If a signal of the i'th node is suppressed at the receiver by more powerful signals, the node takes (or is given) one more carrier and duplicates the data it is transmitting on its first carrier on the additional carrier. As a result the i'th node will transmit data in parallel on two carriers, which is the equivalent of doubling the initial signal power (i.e., providing an about 3 dB increase). As will be appreciated, this approach can be extended to several duplications (replications). For example, if the duplication of data is still not sufficient to provide a signal of desirable magnitude, the node may replicate its data on a third carrier. This will provide an additional 1.76 dB power gain in comparison with the two carrier transmission. The process of power increasing may be continued by additional data replications. In fact, Table 1 shows the power gain as a function of a number of replications. (Note that a number of used carriers is equal to number of replications plus 1). Table 1 also shows the power increment as a function of a number of replications.

TABLE 1

| | Number of Replications | | | | | | |
|---|---|---|---|---|---|---|---|
| | 1 | 2 | 3 | 4 | 5 | 6 | 7 |
| Power Cain | 3.01 | 4.77 | 6.02 | 7.00 | 7.78 | 8.46 | 9.03 |
| dB | | | | | | | |
| Power | 3.01 | 1.76 | 1.25 | 0.98 | 0.78 | 0.68 | 0.57 |
| Increment dB | | | | | | | |

It should be appreciated that the frequencies on which a carrier is replicated should be chosen carefully and separated as much as possible. Frequency diversity provides additional benefits as discussed hereinafter.

While the above discussion was directed to a node utilizing a single carrier, the data carrier duplication approach can be further extended to a multicarrier node. For example, if some node needs Nc carriers for data transmission and Nd duplications (replications) to increase its power, this node will use a total of Nt carriers, which is defined by

Nt=Nc(Nd+1). (1)

The number of replications Nd required can then be estimated by the following formula:

Nd=round(2^{a})−1; a=G/3 (2)

where G is the required power gain in dB, and “round(x)” is a rounding to the nearest integer for x.

When using carriers of equal power for data duplication (replication), the power gain can take only discrete values, for example, 3.01 dB, 4.77 dB and so on as is shown in Table 1. Therefore, by using data replication, the real power gain can differ from the ideal power gain required for complete compensation of a carrier's power variation at the input of the receiver. However, as discussed hereinafter, a more precise approximation can be achieved by utilization of carriers with unequal powers for replication. In addition, it should be noted that the data carrier duplication technique can be used in combination with the conventional algorithms for causing the node to increase or decrease its power.

If the power of some carrier should be increased, the desired power gain may be achieved partly by increasing carrier power and partly by carrier duplication. In particular, assume that some node transmits data on a carrier, that the hub has asked the node to increase this carrier power by 6 dB (four times), and that the node has only 3 dB power in reserve. Then the node can solve the problem in several manners. First, the node can transmit its data on four carriers in parallel without increasing the power on any of the carriers, and the total power gain will be about 6 dB as is required. Second, the node can transmit its data on two carriers in parallel and conventionally increase the power on each carrier by 3 dB for a total power gain of approximately 6 dB. Third, the node can use three carriers in parallel to provide a gain of 4.77 dB, and conventionally increase the power on each of the three carriers by 1.23 dB to provide the remainder of the desired gain. It will be appreciated by those skilled in the art that if the carriers are of different power, different combinations of the numbers of carriers used and the amount of conventional power increase can be utilized.

Before turning to the Figures which show specific manners of implementing data carrier duplication (DCD), it is instructive to review the theoretical basis of DCD and its benefits. In particular, consider the i'th carrier within a set of M orthogonal carriers. After FFT (fast Fourier transform) processing in the receiver, this carrier is transformed into two real numbers Xᵢ and Yᵢ. If all carriers are not completely orthogonal, then the numbers Xᵢ and Yᵢ are subjected to frequency interference from the other carriers. Interference from each carrier to the i'th carrier is a random value with some unknown distribution depending on the modulation technique and the frequency offset between the two carriers. However, if the number of carriers M is not less than several tens, as what often takes place in real OFDM systems, then the sum of the interferences from all of the other carriers to the i'th carrier has a Gaussian distribution and is equivalent to the additive Gaussian white noise (AWGN) with a certain power spectral density.

So, the optimal coherent accumulation of carriers can be used, bearing the same information, in the channel with AWGN. This accumulation is implemented as a weighted summation of components of duplicated carriers:

$$\begin{matrix}{X}_{Σ} = {\sum }_{i} {A}_{i} * {X}_{i} , & ( 3 a ) \\ {Y}_{Σ} = {\sum }_{i} {A}_{i} * {Y}_{i} , & ( 3 b )\end{matrix}$$

where X_{Σ} and Y_{Σ} are final components of the coherent accumulation used for making the decision about the received point; Xᵢ and Yᵢ are FFT transforms of the i-th carrier within the group of duplicated carriers, and Aᵢ is a weight coefficient, which is a function of the i'th carrier power and the noise power spectral density.

In channels with steady parameters or with frequency nonselective (wideband) fading, the weight coefficients for the group of duplicated carriers do not depend on the carrier frequency and may be set to Aᵢ=1. However, in channels with unequal carrier powers or with selective (narrowband) fading the weight coefficients are functions of current carrier amplitudes. In this case, carrier duplication allows the receiver to mitigate the influence of frequency selective fading.

Actually, expressions (3a) and (3b) illustrate the algorithm of duplicated carriers processing, based on the optimal coherent combination of partial signals. When using the optimal coherent combination of partial signals, the final (integrated) signal-to-noise ratio SNR_{Σ} is equal to a sum of partial signal-to-noise ratios SNRᵢ:

$${SNR}_{Σ} = {\sum }_{i} {SNR}_{i} . \qquad ( 4 )$$

Equation (4) shows that theoretically the data carrier duplication allows the system to reach any SNR gain (any signal power gain).

If all carriers in the group of N duplicated carriers have the same power, then

SNR_{Σ}=N*SNRᵢ, (5)

and the SNR gain in decibels (dB) is equal to

(SNR_{Σ}/SNRᵢ)dB=10*logN. (6)

Thus, for example, if two carriers are combined coherently with the same SNR, the final SNR increase by 3 dB. For three carries the gain will be 4.8 dB, and for four carries 6 dB, and so on. The corresponding results for the power gain are shown in Table 1.

A more detailed explanation of the implementation of duplicated carrier accumulation in the hub of the receiver is useful. In a preferred embodiment of the invention, in the hub receiver the received OFDM signal is processed by an FFT converter (not shown) and then by a frequency equalizer (not shown) (adjustment of amplitudes and phases of received carriers) the same way as in the conventional OFDM receiver. As a result, a set of complex numbers zⱼ=Xⱼ+iYⱼ (j=1 . . . N) is obtained, where N is a number of carriers.

According to the proposed method, the receiver should provide coherent accumulation of duplicated carriers. The corresponding algorithm is carried out by a carrier combination unit (not shown). This unit creates a set of combined carriers in the frequency domain according to the following algorithm: Let X=[X₁ . . . , X_{N}] and Y=[Y₁ . . . Y_{N}] be vectors of real and imaginary parts of carriers at the input of the carrier combination unit; and let X=[X₁ . . . X_{N}] and Y=[Y₁ . . . Y_{N}] be vectors of real and imaginary parts of carriers at the output of the carrier combination unit. The carrier combination unit algorithm is described by a quadrate matrix M, having N columns and rows:

$$M = \begin{matrix}\begin{matrix}\begin{matrix}{A}_{11} {A}_{12} … {A}_{1 N} \\ {A}_{21} {A}_{22} … {A}_{2 N}\end{matrix} \\ …\end{matrix} \\ {A}_{N1} {A}_{N2} … {A}_{NN}\end{matrix} \qquad ( 7 )$$

where Aₖⱼ are the weight coefficients of the coherent accumulation. Matrix M reflects carrier assignment for all nodes, including carrier duplications. The nonzero weight coefficients Aₖⱼ in the matrix M correspond to duplicated carriers. They are functions of carrier amplitudes and the noise PSD (power spectral density) and completely determined by SNR distribution. If duplicated carriers have equal amplitudes and the same PSD, the corresponding weight coefficients may be replaced by 1.

Finally, the algorithm can be described as follows:

X=X*M, (8a)

Y=Y*M. (8b)

The following are examples of matrix M. If all N carriers are used individually (without any duplications), then

$$M = \begin{matrix}1 \; 0 … 0 \\ 0 \; 1 … 0 \\ … \\ 0 \; 0 … 1\end{matrix}$$

Suppose that only the 3-rd and the 4-th carriers are duplicated, then

$$M = \begin{matrix}1 & 0 & 0 \\ 0 & 1 & 0 \\ 0 & 0 & {A}_{33} \\ 0 & 0 & {A}_{43} \\ 0 & 0 & 0 \\ & … & \\ 0 & 0 & 0 \\ 0 & 0 & 0\end{matrix} \begin{matrix}0 & 0 & … & 0 & 0 \\ 0 & 0 & … & 0 & 0 \\ 0 & 0 & … & 0 & 0 \\ 0 & 0 & … & 0 & 0 \\ 0 & 1 & … & 0 & 0 \\ & & … & & \\ 0 & 0 & … & 1 & 0 \\ 0 & 0 & … & 0 & 1\end{matrix}$$

Suppose that the 2-nd, 4-th and 5-th carriers are duplicated, then

$$M = \begin{matrix}1 & 0 \\ 0 & {A}_{22} \\ 0 & 0 \\ 0 & {A}_{42} \\ 0 & {A}_{52} \\ 0 & 0 \\ 0 & 0 \\ … & \\ 0 & 0 \\ 0 & 0\end{matrix} \begin{matrix}0 & 0 & 0 & 0 & 0 & … & 0 & 0 \\ 0 & 0 & 0 & 0 & 0 & … & 0 & 0 \\ 1 & 0 & 0 & 0 & 0 & … & 0 & 0 \\ 0 & 0 & 0 & 0 & 0 & … & 0 & 0 \\ 0 & 0 & 0 & 0 & 0 & … & 0 & 0 \\ 0 & 0 & 0 & 1 & 0 & … & 0 & 0 \\ 0 & 0 & 0 & 0 & 1 & … & 0 & 0 \\ & & & & … & & & \\ 0 & 0 & 0 & 0 & 0 & … & 1 & 0 \\ 0 & 0 & 0 & 0 & 0 & … & 0 & 1\end{matrix}$$

Suppose that the 2-nd, 4-th and 5-th carriers are duplicated, and the 3-rd and 6-th carriers are duplicated, then

$$M = \begin{matrix}1 & 0 \\ 0 & {A}_{22} \\ 0 & 0 \\ 0 & {A}_{42} \\ 0 & {A}_{52} \\ 0 & 0 \\ 0 & 0 \\ … & \\ 0 & 0 \\ 0 & 0\end{matrix} \begin{matrix}0 \\ 0 \\ {A}_{33} \\ 0 \\ 0 \\ {A}_{63} \\ 0 \\ … \\ 0 \\ 0\end{matrix} \begin{matrix}0 & 0 & 0 & 0 & … & 0 & 0 \\ 0 & 0 & 0 & 0 & … & 0 & 0 \\ 0 & 0 & 0 & 0 & … & 0 & 0 \\ 0 & 0 & 0 & 0 & … & 0 & 0 \\ 0 & 0 & 0 & 0 & … & 0 & 0 \\ 0 & 0 & 0 & 0 & … & 0 & 0 \\ 0 & 0 & 0 & 1 & … & 0 & 0 \\ & & … & & … & & \\ 0 & 0 & 0 & 0 & … & 1 & 0 \\ 0 & 0 & 0 & 0 & … & 0 & 1\end{matrix}$$

In other words, components of the combined carriers are equal to scalar products of vectors X or Y and Aⱼ=[Aᵢⱼ A₂ⱼ . . . A_{Nj}], namely

$$\begin{matrix}{X}_{j} = ( {XA}_{j} ) = {\sum }_{k = 1}^{N} {A}_{kj} * {X}_{j} , & ( 9 a ) \\ {Y}_{j} = ( {YA}_{j} ) = {\sum }_{k = 1}^{N} {A}_{kj} * {Y}_{j} . & ( 9 b )\end{matrix}$$

Complex numbers zⱼ=Xⱼ+i Yⱼ for duplicated carriers from the output of carrier combination unit come to the usual QAM demodulator.

Previously, it was stated that power control utilizing data carrier duplication promotes the solving of other issues in multipoint-to-point OFDM system implementations. One such issue is frequency selective fading. A wireless channel with Gaussian noise and frequency selective Rayleigh fading may be considered. If a single carrier is modulated with BPSK, and the receiver uses the optimal coherent processing, as set forth in John Proakis, “Digital Communications”, 4-th edition, McGraw-Hill, 2001, (which is hereby incorporated by reference herein in its entirety), then the probability of error p₁ is equal to:

p₁≈¼[m(α²)PT/No]=(1/P)*{¼[m(α²)T/No]}, (10)

where [m(α²)PT/No] is the average signal-to-noise ratio, P is the transmit signal power, T is the symbol duration, No is the noise power spectral density, and m(α²) is the average power attenuation in the Rayleigh channel (α is a channel parameter; it is a Rayleigh-distributed value, and α² is a chi-square distributed value). It is seen that the bit error rate (BER) is inversely proportional to the transmit power: a doubling of the power results in a halving of the BER. Therefore, it will be appreciated that the increasing of the transmit power is not an efficient way of mitigating selective fading influence.

On the other hand, if the same data is transmitted on N carriers in parallel with independent Rayleigh fading, and the carriers are coherently accumulated in the receiver, then, as set forth in previously incorporated John Proakis, “Digital Communications”, 4-th edition, McGraw-Hill, 2001, (pg. 819, Formula 4.3-13) the probability of error p₂is equal to:

p₂≈[(2N−1)!/N!]*[¼*m(α²)PT/No]^{N}=(1/P) ^{N}*[(2N−1)!/N!]*[¼*m(α²)T/No]^{N}. (11)

In this case, the BER is inversely proportional to the transmit power to the power N. As a result, doubling of the power yields a BER decrease by a factor of 2^{N}. Therefore, it will be appreciated that carrier duplication is an efficient way to mitigate selective fading influence. For example, for N=2 (number of duplications is equal to 1), the probability of error p₂ is defined by:

p₂≈3*(1/P)^{2 *}[¼*m(α²)T/No]². (12)

Given the above, the performance provided by utilizing the direct power increase of the prior art may be compared with the performance provided by the carrier duplication of the invention. In particular, assume that the node is requested by the hub to increase power by 3 dB. If this request is carried out with a direct power increase by 3 dB, the performance is calculated according to equation (10) above; whereas if the request is carried out with carrier duplication, the performance is calculated according to equation (12) above. If the initial (before power increasing) BER is equal to p₀=¼[m(α^{a})PT/No], then the performance improvement will be

p₁/p₂=⅓p₀. (13)

So, when p₀<⅓, the system with carrier duplication provides performance gain comparable to the system using the standard power increasing methods. However, when p₀<<⅓ the performance gain utilizing carrier duplication (replication) may be very considerable.

In radio channels with Ricean or Lognormal fading as well as in channels with correlated frequency selective fading the performance gain may be less than set forth in equation (10) above, but in any case it still will be considerable. Thus, the DCD based power control method provides an additional benefit for OFDM wireless systems; namely, it allows the systems to mitigate efficiently the influence of frequency selective fading. It should be noted that this benefit takes place when duplicated carriers have sufficient frequency diversity.

As previously set forth, frequency offset is a well known problem in OFDM systems. In the point-to-multipoint mode, frequency offset is the same for all carriers, but in the multipoint-to-point mode, carriers from different nodes have different frequency offsets. According to Bill McFarland et al., “The 5-UP Protocol for Unified Multiservice Wireless Networks”, IEEE Communications, Vol.39, No.11, November 2001, which is hereby incorporated by reference herein in its entirety, in multipoint-to-point systems the required frequency adjustment between nodes is accomplished by locking all the transmitters to the frequency transmitted by the Hub. In Jean Armstrong, “Analysis of New and Existing Methods of Reducing Intercarrier Interference Due to Carrier Frequency Offset in OFDM”, IEEE Transactions on Communications, Vol.47, No3, March 1999, and in Yuping Zhao, and Sven-Gustav Haggman, “Intercarrier Interference Self-Cancellation Scheme for OFDM Mobile Communication Systems”, IEEE Transactions on Communications, Vol.49, No.7, July 2001 (both of which are hereby incorporated by reference herein in their entireties), a self-cancellation method of frequency offset reducing is proposed for point-to-multipoint systems. The proposed method consists in special modulation of adjacent carriers, which partly compensates undesirable components caused by frequency offset. The obvious disadvantage of the method is a utilization of adjacent carriers; i.e., it does not allow the system to get benefits from a frequency diversity of carriers. However, the proposed DCD power control method of the invention allows the OFDM system to mitigate the influence of frequency offset without lacking benefits from frequency diversity.

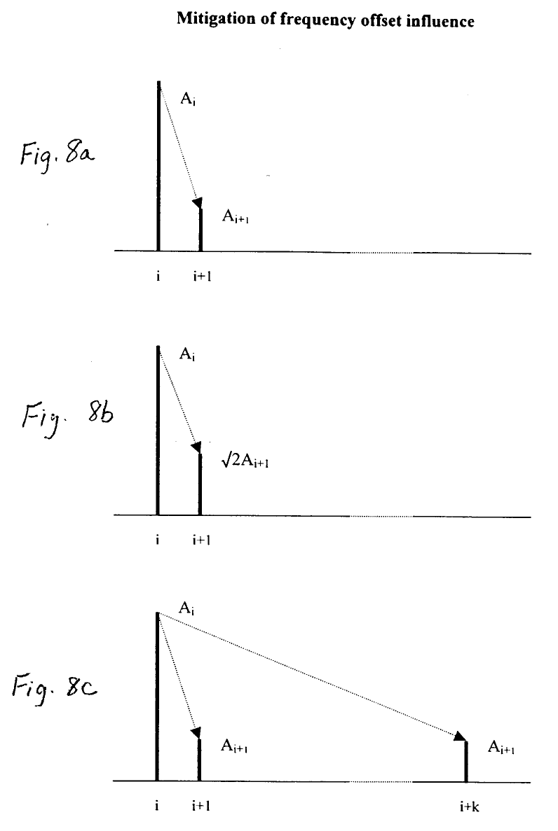

FIGS. 8a-8c illustrate this phenomenon qualitatively. FIG. 8a shows two carriers from a set of carriers: the i'th carrier with frequency ωᵢ and amplitude Aᵢ, and the (i+1)'th carrier with frequency ωᵢ₊₁ and amplitude Aᵢ₊₁<Aᵢ. If the frequency offset Δω≠0, i.e., ωₙ≠nω₀, where ω₀=2π/T and T is the FFT interval, then the (i+1)'th carrier is subjected to severe interference from the i'th carrier, which is proportional to Aᵢ and inversely proportional to a frequency difference between the carriers.

FIG. 8b shows the same two carriers as in FIG. 8a, but with the (i+1)'th carrier increased by 3 dB power. This example corresponds to the conventional method of power control, based on increasing power of the weakest signal.

FIG. 8c corresponds to the method of power control of the invention utilizing carrier duplication (replication). In this case the 3 dB power increase is achieved by transmitting the information symbols on two carriers; the (i+1)'th carrier and the (i+k)'th carrier with the same power. It is intuitively expected that the frequency offset influence will be less in the case of FIG. 8c because of considerable frequency diversity of the interfered signals.

The influence of frequency offset may be considered quantitatively. In general, the interference from the i'th carrier to the (i+k)'th carrier Iₖ is

Iₖ≈AᵢT* sin Δω/2kω₀. (14)

On the other hand, the useful signal at the (i+k)'th carrier Sₖ is

Sₖ≈Aᵢ₊ₖT/2. (15)

So, the signal-to-interference ratio SIRₖ for the (i+k)'th carrier is

SIRₖ=Sₖ/Iₖ≈(Aᵢ₊ₖ/Aᵢ)*(kω₀/ sin Δω). (16)

To increase the SIR₁ for the (i+1)'th carrier, the corresponding transmitter can increase the carrier power as in the prior art. If, for example, the carrier power is increased by 3 dB, as it is shown in FIG. 8b, the corresponding SIR₁ according to equation (16) will be equal to:

SIR₁≈√2*(Aᵢ₊₁/Aᵢ)*(ω₀/ sin Δω). (17)

Another way to increase the signal-to-interference ratio is to duplicate the (i+1)'th carrier data on the (i+k)'th carrier in accord with the invention, and as is shown in FIG. 8c. It is qualitatively clear that the interference from the i'th carrier to the (i+k)'th carrier will be much less than the interference to the (i+1)'th carrier. Now the integrated signal-to-interference ratio SIR_{d} for the duplication can be quantitatively estimated using formula (13). Having assumed that for the optimal carriers combination the integrated SIR will equal a sum of partial SIRs, the following is obtained:

SIR_{d}≈(Aᵢ₊₁/Aᵢ)*(ω₀/ sin Δω)+(Aᵢ₊ₖ/Aᵢ)*(kω₀/ sin Δω) (18)

If Aᵢ₊₁=Aᵢ₊ₖ, then

SIR_{d}≈(Aᵢ₊₁/Aᵢ)*(ω₀/ sin Δω)*(1+k). (19)

Comparing equations (17) and (19), it is seen that the method of the invention results in a gain G relative to the method of the prior art, where

G≈SIR_{d} / SIR₁=(1+k)/√2. (20)

Since k is a nonzero integer, the gain is not less than √2. So, it will be appreciated that the DCD based power control method of the invention provides yet an additional benefit for OFDM wireless systems; namely, it allows the systems to mitigate efficiently the influence of frequency offset.

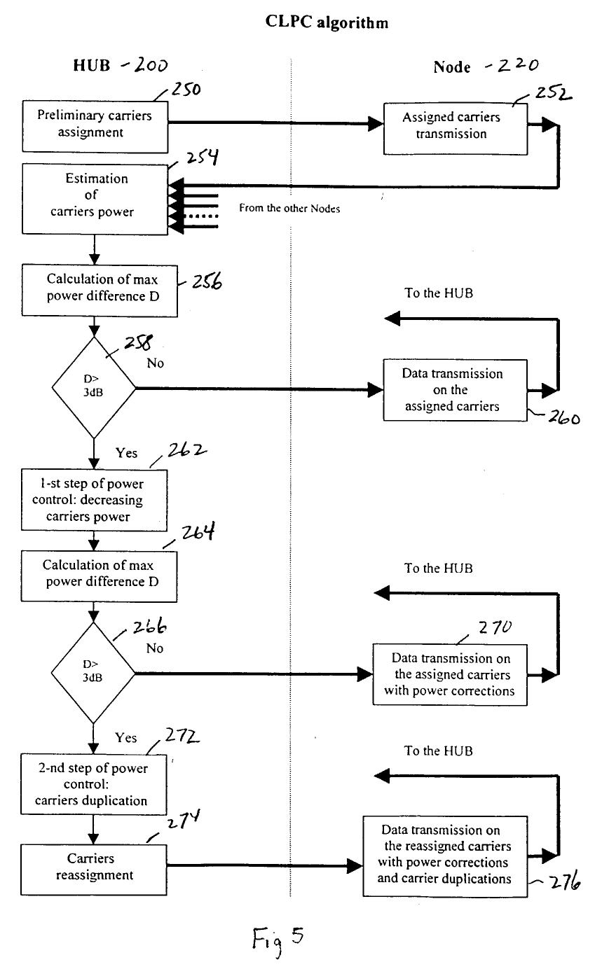

Having reviewed the theoretical basis of data carrier duplication (replication), it will be appreciated by those skilled in the art that many different methods, techniques, and algorithms can be utilized in order to implement DCD. A first preferred mechanism of implementing DCD is seen generally in FIG. 4 and is called closed loop power control. In FIG. 4, a hub transceiver 200 and a node transceiver 220 are in contact with each other via antenna 231, 233. In the closed loop power control method, the hub 200 has the intelligence to conduct several functions. In particular, the hub 200 receives a signal from the node 220 and estimates its carrier power at 240. Based on the carrier power, the hub 200 calculates the power gain required for each node whose signal it receives. Then, based on the number of available carriers, and the power gain required for the nodes, the hub determines at 242 the number of and frequency of the carrier replications the node 220 should implement, as well as whether, and if so, how much the node 220 should increase (or decrease) its transmitter power. Final determinations at 244 are transmitted by the hub 200 to the node 200. The node 220, in turn, receives and implements at 246 carrier and power assignments from the hub, and loads symbols (i.e., distributes the symbols to the carriers) at 248 accordingly.

Details of the preferred closed loop power control method are seen in FIG. 5 which shows several interactions between the hub 200 and node 220. In particular, at 250 the hub provides a preliminary assignment of carriers for all nodes participating in a given session. At 252, all active nodes transmit on the assigned carriers with a maximum possible power level or with a given initial power level. At 254, the hub receiver measures and estimates the power of all of the received individual carriers. At 256, the hub calculates the maximum power difference D between the different node channels (carriers). If the difference D between powers of the individual carriers does not exceed a given threshold (for example, 3 dB), then at 258, the hub allows the nodes to transmit data on the preliminarily assigned carriers with no power changes, and at 260, the nodes transmit data on those carriers with no power changes. On the other hand, if the difference D between powers of the individual carriers exceeds the given threshold (for example, 3 dB) at 258, then the hub continues at steps 262 and 264 to conduct a power correction. Thus, at 262, (in a manner known in the prior art), the hub determines whether the power of certain nodes can be decreased while still providing a suitable signal. Then at 264, with the decreased power, a determination is made as to whether, if after that correction, the difference between powers of the individual carriers is within the given threshold (for example, 3 dB). If the difference is determined at 266 to be within the threshold, at 268, the hub allows the nodes to transmit data on the preliminary assigned carriers with the estimated power changes and at 270, the nodes transmit data on those carriers with the assigned power correction. Otherwise, at step 272, the hub determines the number of replications that are required for each node to cause the power difference to be within the desired threshold, and at step 274 assigns additional carriers for those nodes with insufficient power. At 276, the nodes accept their new carriers and transmit data with carrier replications and power corrections.

It is noted that the determination of the number of replications required at step 276 may depend upon the characteristics of the channels at particular frequencies. In addition, the number of replications utilized for any given node could depend on the number of carriers available for replication, the ability of node transmitters to increase their transmitting power without replication, and the number of nodes which require replication. Further, it should be noted that the assignment of carriers at step 278 could involve a complete reassignment of carriers in order to implement maximum frequency diversity of carrier groups carrying replicated data. Also, it should be appreciated that if after power changes and carrier replications it is still not possible to obtain a power difference within the desired threshold, it may be necessary for the hub to drop the node which does not meet the threshold requirements.

While one preferred closed loop power control algorithm is shown in FIG. 5, it will be appreciated that other such algorithms can be utilized.

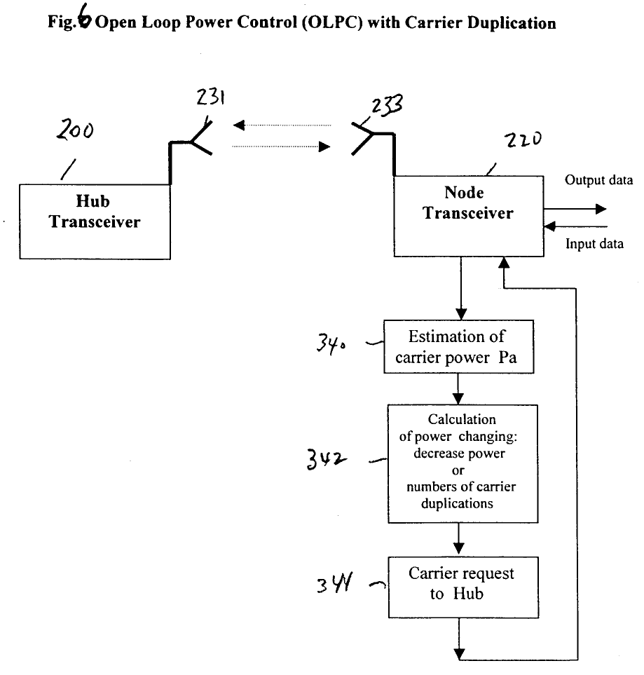

A second preferred method of implementing DCD is called the “open loop power control” (OLPC) scheme. OLPC works when the hub-node channel is reciprocal, which is as a rule the usual situation. In this scheme the node makes independent decisions about carrier duplications and sends the corresponding request on carriers assignment to the hub. The mechanism is illustrated generally in FIG. 6, the hub transceiver 200 and the node transceiver 220 are in contact with each other via the antenna 231, 233. However, as opposed to the closed loop arrangement of FIG. 5 where the intelligence for implementing DCD is found mostly in the hub 200, in FIG. 6, most of the intelligence required to implement DCD is found in the node 220. Thus, the functions of the hub 200 and node 220 are different. In the open loop control mechanism, the node estimates the power of its carrier at 340, calculates a mechanism for changing its power at 342, including whether it can decrease its power and/or whether it will need to replicate its data on one or more additional carriers, and sends on its assigned carrier at 344 a carrier request to the hub.

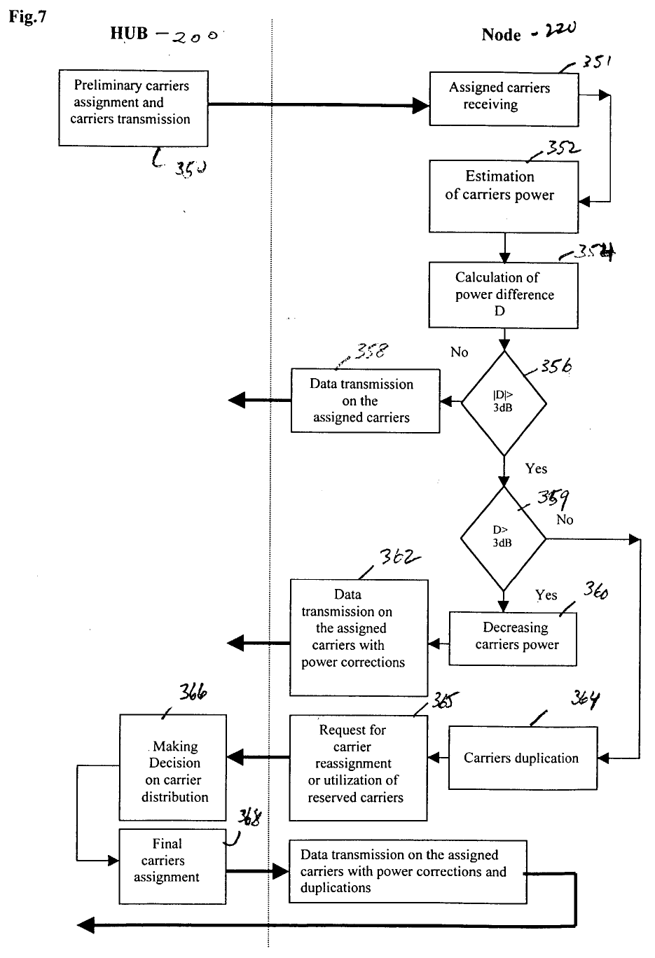

The preferred method of implementing the open loop power control algorithm is seen in FIG. 7. At 350, the hub 300 provides a preliminary assignment of carriers for all nodes 320 participating in a given session. At 351, each node receives the preliminary assignment, and at 352, each node receiver measures and estimates the average power Pa of the assigned carriers transmitted by the hub 300. Then, at 354, each node calculates the difference Dp between the estimated power and some predetermined nominal level Pn; i.e., Dp=Pa−Pn; If at 356, the calculated difference Dp is within a given threshold value ±Th, (e.g., if Dp in decibels is within −3 dB<Dp<3 dB), then at 358 the node 320 transmits data on the preliminary assigned carriers without any power changes. If at 359, the difference Dp>Th (for example, if Dp>3 dB), then at 360 the node decreases the power of its preliminary assigned carrier in order to cause the, difference between the corrected power and the predetermined nominal to within the threshold (±Th). Then, at 362, each node transmits data on its preliminary assigned carrier with the corresponding power changes. However, if at 359 the difference Dp<−Th (for example, if Dp<−3 dB), then the node at 364 makes a determination as to the number of replications (i.e., the number of carriers) it requires for the corresponding power gain, and at 365 transmits to the hub the request for additional carriers. As a less preferred alternative, any node requiring additional carriers may use predetermined reserved carriers and transmit data on those duplicated carriers. In the preferred OLPC embodiment of the invention, at 366, the hub receives the request for additional carriers, and at 368, may grant or deny the requests by sending a new “preliminary” assignment of carriers. In addition, if desired, prior to sending a new “preliminary” assignment the hub may reassign carriers in order to implement maximum frequency diversity of carrier groups carrying replicated data. In any event, at 370, the nodes transmit data on the newly assigned carriers with duplications and power correction where applicable.

There have been described and illustrated herein methods, apparatus, and systems for orthogonal frequency division multiplexing utilizing power control. While particular embodiments of the invention have been described, it is not intended that the invention be limited thereto, as it is intended that the invention be as broad in scope as the art will allow and that the specification be read likewise. Thus, while particular method steps have been disclosed in a certain order, it will be appreciated that it may be possible to perform some steps in a different order. Also, while particular apparatus has been disclosed, it will be recognized that the invention may be implemented with different apparatus with similar results obtained. Further, while embodiments of the invention included taking differences between various signal powers and comparing them to various thresholds, it will be appreciated by those skilled in the art that the differences and the comparisons may be made with functions of the differences (the function being the value one for a mere subtraction, or more complex, as desired). It will therefore be appreciated by those skilled in the art that yet other modifications could be made to the provided invention without deviating from its spirit and scope as claimed.

We claim:

1. A telecommunications system, comprising:
a) a hub having a receiver means for receiving orthogonal frequency division multiplexed (OFDM) signals and a transmitter for transmitting OFDM signals over a plurality of first carriers; and
b) a plurality of nodes, each node having a receiver means for receiving OFDM signals and a transmitter means for transmitting OFDM signals, said transmitter means for at least one of said plurality of nodes including means for increasing a transmission power of that node by replicating information transmitted by said transmitter means of that node on a plurality of second carriers.

2. A telecommunications system according to claim 1, wherein:
said hub includes means for assigning a plurality of said second carriers for at least one of said nodes, said plurality of second carriers being chosen by said means for assigning to provide frequency diversity which mitigates selective fading.

3. A telecommunications system according to claim 1, wherein:
said hub provides said plurality of nodes with a preliminary assignment-of said second carriers.

4. A telecommunications system according to claim 1, wherein:
said hub includes means for measuring signal powers of said plurality of second carriers and further includes means for taking differences between said signal power of said plurality of second carriers and for comparing a function of said differences to at least one threshold.

5. A telecommunications system according to claim 4, wherein:
said hub includes means for determining a number of replications of information required by any of said plurality of nodes based on a function of a difference between said signal power of a second carrier used by said node and said threshold.

6. A telecommunications system according to claim 5, wherein:
said hub includes means for assigning a plurality of second carriers for at least one of said nodes, said plurality of second carriers being chosen by said means for assigning to provide frequency diversity which mitigates selective fading.

7. A telecommunications system according to claim 6, wherein:
said hub includes means for processing replicated information sent by at least one of said nodes.

8. A telecommunications system according to claim 1, wherein:
said first plurality of carriers and said second plurality of carriers are identical.

9. A telecommunications system according to claim 8, wherein:
each of said plurality of nodes includes means for measuring signal power of a carrier on which it is to transmit data and means for comparing said signal power to at least one nominal value.

10. A telecommunications system according to claim 9, wherein:
each of said plurality of nodes includes means for determining a number of replications of said information required by that node based on a function of a difference between said signal power of a carrier used by said node and said nominal value.

11. A telecommunications system according to claim 10, wherein:
said hub includes means for processing replicated information sent by at least one of said nodes.

12. A telecommunications system according to claim 1, wherein:
said hub includes means for processing replicated information sent by at least one of said nodes.

13. A hub for use in an orthogonal frequency division multiplexed (OFDM) telecommunications system having said hub and a plurality of nodes, said hub comprising:
a) receiver means for receiving orthogonal frequency divisional multiplexed (OFDM) signals;
b) transmitter means for transmitting OFDM signals over a plurality of first carriers; and
c) means for assigning second carriers to the plurality of nodes and for assigning at least one additional second carrier to at least one of the plurality of nodes for carrying a replication of information to be transmitted on an assigned second carrier.

14. A hub according to claim 13, further comprising:
means for processing replicated information sent by at least one of the plurality of nodes.

15. A hub according to claim 13, wherein:
said at least one additional second carrier is chosen by said means for assigning carriers to provide frequency diversity which mitigates selective fading.

16. A hub according to claim 13, further comprising:
means for measuring signal powers of the plurality of second carriers; and
means for taking differences between said signal power of the plurality of second carriers and for comparing a function of said differences to at least one threshold.

17. A hub according to claim 16, further comprising:
means for determining a number of additional second carriers required by one of the nodes based on a function of difference between said signal power of a second carrier used by the node and said threshold.

18. A hub according to claim 17, further comprising:
means for processing replicated information sent by at least one of the plurality of nodes.

19. A hub according to claim 13, wherein:
said first plurality of carriers and said second plurality of carriers are identical.

20. A node for use in an orthogonal frequency division multiplexed (OFDM) telecommunications system having a hub and additional other nodes, said node comprising:
a) receiver means for receiving orthogonal frequency divisional multiplexed (OFDM) signals from the hub;
b) transmitter means for transmitting information, said transmitter means including means for increasing a transmission power of said node by replicating said information transmitted by said transmitter means simultaneously on a plurality of carriers.

21. A node according to claim 20, wherein:
said transmitter means includes means for adjusting transmission power of said node without replicating said information.

22. A node according to claim 20, further comprising:
means coupled to said receiver means for estimating carrier power of at least one of said carriers carrying said OFDM signals.

23. A node according to claim 22, further comprising:
means for comparing an estimated carrier power to a threshold power.

24. A node according to claim 23, wherein:
said transmitter means includes means for adjusting transmission power of said node without replicating said information in response to a determination of said means for comparing.

25. A node according to claim 23, wherein:
said transmitter means includes means responsive to said means for comparing for determining how many of said carriers on which to replicate said information.

26. A method for adjusting the transmitting power of a node in an orthogonal frequency division multiplexed (OFDM) telecommunications system having a hub with receiver means and transmitter means and a plurality of nodes each having receiver means and transmitter means, said method comprising:
a) assigning a node signal carrier to each of said plurality of nodes;
b) estimating signal power of said respective node signal carriers; and
c) adjusting transmitting power of at least one of said plurality of nodes by assigning an additional node signal carrier to that node, such that that node transmits identical information on said additional node signal carrier and on an originally assigned node signal carrier.

27. A method according to claim 26, wherein:
said assigning a carrier comprises having the hub provide OFDM signals on a plurality of hub signal carriers to each of the plurality of nodes, said OFDM signals carrying node signal carrier assignment information.

28. A method according to claim 27, wherein:
said estimating signal power comprises having the nodes send OFDM signals on said node signal carriers to the hub and having the hub estimate signal power therefrom.

29. A method according to claim 28, wherein:
said adjusting comprises having the hub compare estimates of node signal carrier signal power to a threshold.

30. A method according to claim 29, wherein:
said adjusting further comprises having the hub send a control signal to at least one of the nodes to further increase or decrease the carrier power of the node without utilizing an additional node signal carrier.

31. A method according to claim 27, wherein:
said estimating signal power comprises having the nodes estimate signal power from the OFDM signals sent by the hub which are carrying the node signal carrier assignment information, wherein said node signal carriers and said hub signal carriers are identical.

32. A method according to claim 31, wherein:
said estimating signal power comprises having the nodes estimate signal power from OFDM signals sent by the hub.

33. A method according to claim 32, wherein:
said adjusting comprises having the node compare estimates of hub signal carrier signal power to a threshold.

34. A method according to claim 33, wherein:
said adjusting further comprises having at least one of the nodes further increase or decrease the carrier power of the node without utilizing an additional node signal carrier.

35. A method according to claim 34, wherein:
said adjusting further comprises, in response to the comparison of the estimates of hub signal carrier signal power to the threshold, having the node request at least one additional node signal carrier on which to transmit information.

36. A method according to claim 26, wherein:
said assigning an additional node signal carrier comprises assigning an additional node signal carriers in a manner which provides frequency diversity and mitigates selective fading.
